(19) United States
(12) Patent Application Publication
(10) Pub. No.: US 2012/0109726 A1
(43) Pub. Date: May 3, 2012

(54) Methods and Systems for Trigger-Based Updating of an Index File Associated with a Captured Media Content Instance

(75) Inventor: Michael P. Ruffini, Methuen, MA (US)

(73) Assignee: VERIZON PATENT AND LICENSING, INC., Basking Ridge, NJ (US)

(21) Appl. No.: 12/916,504

(22) Filed: Oct. 30, 2010

(51) Int. Cl. G06Q 30/00; H04N 7/10

(52) U.S. Cl. 705/14.4; 705/14.66; 725/32

(57) ABSTRACT

An exemplary method includes a media content provider subsystem capturing data representative of a media content instance during transmission of the media content instance, detecting, during the capturing, a trigger included in the transmission and indicating a start time and an end time of an advertisement break included in the media content instance, and dynamically updating an index file associated with the captured media content instance with data representative of the start time and the end time of the advertisement break. Corresponding methods and systems are also described.

### BACKGROUND INFORMATION

Many media content access devices, such as set-top box devices and the like, include a digital video recording (“DVR”) application that allows a user to record and then view or otherwise experience recorded media content in one or more “trick play” modes. For example, a user may play back a presentation of a media content instance, skip to a different position within a media content instance, fast forward within a media content instance, and/or rewind within a media content instance.

However, it is practically impossible for a media content access device to record the plethora of media content instances broadcast or otherwise provided by a television service provider on a daily basis. Hence, occasions may arise in which a user of a media content access device may desire to view a previously broadcast television program, for example, that was not recorded by the media content access device. In such occasions, it would be beneficial for both the user and the television service provider if the television service provider were able to provide a previously broadcast television program as a video-on-demand asset.

### BRIEF DESCRIPTION OF THE DRAWINGS

The accompanying drawings illustrate various embodiments and are a part of the specification. The illustrated embodiments are merely examples and do not limit the scope of the disclosure. Throughout the drawings, identical or similar reference numbers designate identical or similar elements.

FIG. 1 illustrates an exemplary media content delivery system according to principles described herein.

FIG. 2 illustrates an exemplary implementation of the system of FIG. 1 according to principles described herein.

FIG. 3 illustrates exemplary components of a media content delivery subsystem according to principles described herein.

FIG. 4 illustrates exemplary components of a media content access subsystem according to principles described herein.

FIG. 5 illustrates an exemplary method of trigger-based updating of an index file associated with a captured media content instance according to principles described herein.

FIG. 6 shows a graphical representation of an exemplary captured media content instance according to principles described herein.

FIG. 7 shows triggers embedded in the captured media content instance of FIG. 6 according to principles described herein.

FIG. 8 shows a graphical representation of an exemplary index file according to principles described herein.

FIG. 9 shows a graphical representation of a captured media content instance along with a graphical representation of an advertisement stream according to principles described herein.

FIG. 10 illustrates an exemplary method of dynamically inserting an advertisement into a presentation of a captured media content instance according to principles described herein.

FIG. 11 illustrates an exemplary computing device according to principles described herein.

### DETAILED DESCRIPTION OF PREFERRED EMBODIMENTS

Exemplary methods and systems for trigger-based updating of an index file associated with a captured media content instance are described herein. As described in more detail below, a media content delivery subsystem may capture data representative of a media content instance during a transmission of the media content instance. The captured media content instance may be maintained by the media content delivery subsystem for future presentation to one or more users of media content access subsystems. For example, a television service provider may capture a broadcast television program and offer the captured television program as a video-on-demand asset for future viewing by a user by way of an access device (e.g., a set-top box).

In some examples, a captured media content instance may include a media content program having advertisement breaks temporally interspersed therein. As a result, each time a user views a particular captured media content instance, the same advertisements that were originally presented during the advertisement breaks may be presented to the user. Over time, some of these advertisements may become stale or outdated. Consequently, the user may be more apt to ignore or skip over one or more of the advertisements. Hence, as will be described in more detail below, the methods and systems disclosed herein may facilitate dynamic replacement of one or more advertisements included in a captured media content instance. In this manner, one or more new and/or updated advertisements may be presented to a user each time the user views the captured media content instance.

To facilitate dynamic replacement of advertisements included in a captured media content instance, the media content delivery subsystem may be configured to detect a trigger that is included in a transmission of a media content instance and that indicates a start time and an end time of an advertisement break included in the media content instance. Upon detecting the trigger, the media delivery subsystem may dynamically update an index file associated with the captured media content instance with data representative of the start time and the end time of the advertisement break within the captured media content instance. As will be described in more detail below, the index file may be used by the media content delivery subsystem to insert one or more advertisements into a presentation of a captured media content instance.

As used herein, the term “media content” may refer generally to any content made accessible by a media content delivery subsystem to a media content access subsystem. The term “media content instance” as used herein may refer generally to any television program, on-demand media program, pay-per-view media program, broadcast media program (e.g., broadcast television program), multicast media program, narrowcast media program, IPTV content, advertisement (e.g., commercial), video, movie, song, or any segment, component, or combination of these or other forms of media content that a user may view or otherwise experience. A “captured media content instance” refers to a media content instance that has been recorded, stored, or otherwise acquired by a media content delivery subsystem.

As used herein, the term “trigger” may refer to any data or signal (e.g., a SCTE-35 cue tone) that may be included in a transmission of a media content instance and that may be descriptive of an upcoming advertisement break included in the media content instance. For example, a trigger may include data indicative of a temporal position (e.g., a start time and an end time) of an advertisement break within a data stream representative of a media content instance. The trigger may indicate a start time and an end time in any suitable way. For example, the trigger may indicate a start time and a duration of the advertisement break. A trigger may additionally or alternatively include data indicative of any other characteristic of an advertisement break as may serve a particular implementation. As will be described in more detail below, a trigger may be used by a media content delivery subsystem to identify an advertisement break reserved for a service provider so that the service provider may present one or more advertisements (e.g., targeted and/or local advertisements) during the advertisement break.

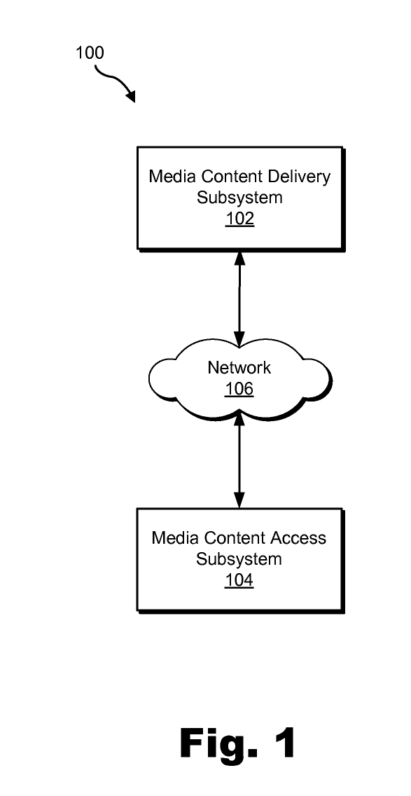

FIG. 1 illustrates an exemplary media content delivery system 100 (or simply “system 100”). System 100 may include a media content delivery subsystem 102 (or simply “delivery subsystem 102”) and a media content access subsystem 104 (or simply “access subsystem 104”) in communication with one another via a network 106. Access subsystem 104 may be configured to communicate with and receive one or more media content instances and/or advertisements from delivery subsystem 102.

Delivery subsystem 102 and access subsystem 104 may communicate using any suitable communication technologies, devices, networks, media, and protocols supportive of remote data communications. For example, delivery subsystem 102 and access subsystem 104 may communicate over network 106 using any communication platforms and technologies suitable for transporting media content and/or communication signals, including known communication technologies, devices, transmission media, and protocols supportive of remote data communications, examples of which include, but are not limited to, data transmission media, communications devices, Transmission Control Protocol (“TCP”), Internet Protocol (“IP”), File Transfer Protocol (“FTP”), Telnet, Hypertext Transfer Protocol (“HTTP”), Hypertext Transfer Protocol Secure (“HTTPS”), Session Initiation Protocol (“SIP”), Simple Object Access Protocol (“SOAP”), Extensible Mark-up Language (“XML”) and variations thereof, Simple Mail Transfer Protocol (“SMTP”), Real-Time Transport Protocol (“RTP”), User Datagram Protocol (“UDP”), Global System for Mobile Communications (“GSM”) technologies, Code Division Multiple Access (“CDMA”) technologies, Evolution Data Optimized Protocol (“EVDO”), Time Division Multiple Access (“TDMA”) technologies, radio frequency (“RF”) signaling technologies, wireless communication technologies (e.g., Bluetooth, Wi-Fi, etc.), optical transport and signaling technologies, live transmission technologies (e.g., media streaming technologies), media file transfer technologies, in-band and out-of-band signaling technologies, and other suitable communications technologies.

Network 106 may include one or more networks or types of networks (and communication links thereto) capable of carrying communications, media content, and/or data signals between delivery subsystem 102 and access subsystem 104. For example, network 106 may include, but is not limited to, one or more wireless networks (e.g., satellite media broadcasting networks or terrestrial broadcasting networks), mobile telephone networks (e.g., cellular telephone networks), closed media networks, open media networks, subscriber television networks (e.g., broadcast, multicast, and/or narrowcast television networks), closed communication networks, open communication networks, satellite networks, cable networks, hybrid fiber coax networks, optical fiber networks, broadband networks, narrowband networks, the Internet, wide area networks, local area networks, public networks, private networks, packet-switched networks, and any other networks capable of carrying data and/or communications signals between delivery subsystem 102 and access subsystem 104. Communications between delivery subsystem 102 and access subsystem 104 may be transported using any one of above-listed networks, or any combination or sub-combination of the above-listed networks.

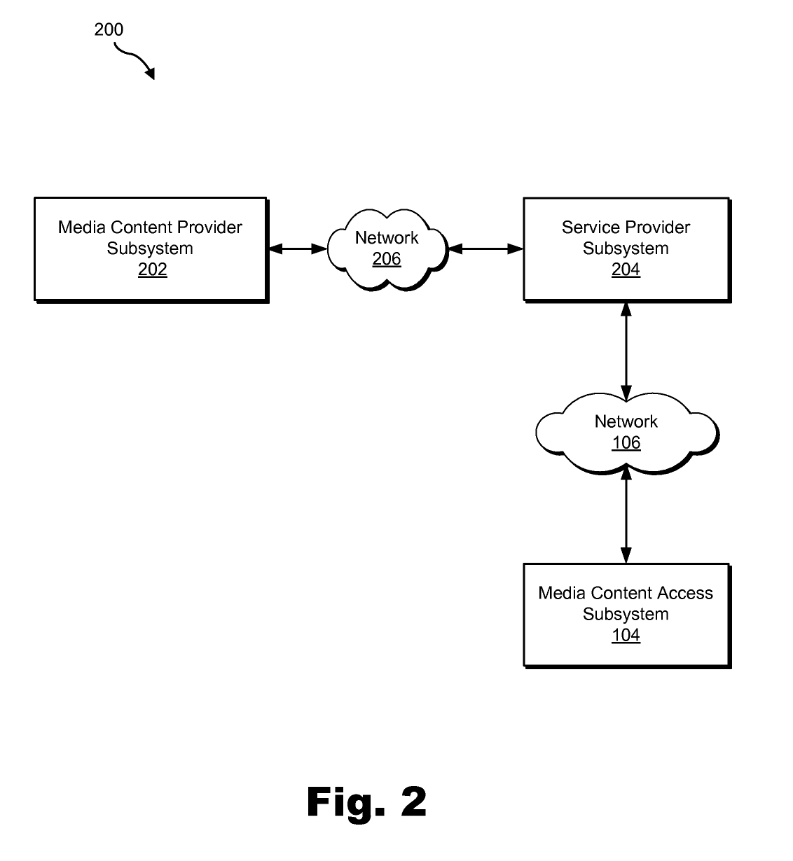

FIG. 2 illustrates an exemplary implementation 200 of system 100. Implementation 200 may include a media content provider subsystem 202, a service provider subsystem 204, and access subsystem 104. Media content provider subsystem 202 and service provider subsystem 204 may be configured to communicate with one another by way of network 206. Service provider subsystem 204 and access subsystem 104 may be configured to communicate with one another by way of network 106. Networks 106 and 206 may each include one or more of the networks described herein.

Media content provider subsystem 202 may be associated with a particular media content provider (e.g., NBC, ESPN, etc.) and may be configured to transmit data representative of a media content instance (e.g., a television program, a movie, a sporting event, etc.) to service provider subsystem 204 by way of network 206. Service provider subsystem 204 may be associated with a particular service provider (e.g., a television service provider) and may provide the media content instance to access subsystem 104 in any suitable manner. In some examples, service provider subsystem 204 may capture the media content instance and store the media content instance. The captured media content instance may be subsequently provided to access subsystem 104 in the form of a video-on-demand asset or in any other manner as may serve a particular implementation.

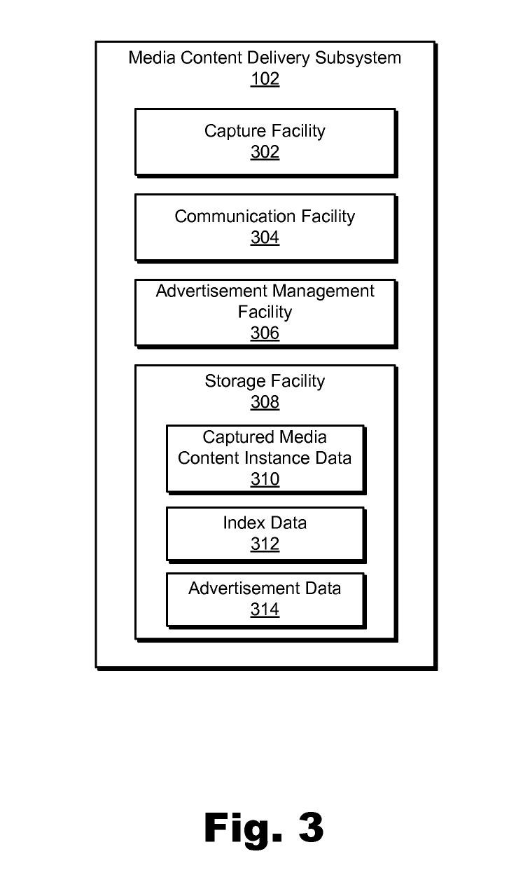

Returning to FIG. 1, exemplary components of delivery subsystem 102 and access subsystem 104 will now be described. FIG. 3 illustrates exemplary components of delivery subsystem 102. As shown in FIG. 3, delivery subsystem 102 may include a media content capture facility 302 (or simply “capture facility 302), a communication facility 304, an advertisement management facility 306, and a storage facility 308, which may be in communication with one another using any suitable communication technologies. It will be recognized that although facilities 302-308 are shown to be separate facilities in FIG. 3, any of those facilities may be combined into a single facility as may serve a particular implementation.

Capture facility 302 may be configured to capture data representative of a media content instance during a transmission of the media content instance. For example, capture facility 302 may capture a media content instance during a broadcast, multicast, and/or narrowcast of the media content instance.

Capture facility 302 may be configured to capture the media content instance in any suitable manner. For example, the media content instance may be provided by a media content provider (e.g., ESPN) as part of a Moving Pictures Expert Group (“MPEG”) stream (e.g., an MPEG-2 or MPEG-4 stream) that is to be transmitted to one or more media content access devices by way of a service provider. During the transmission of MPEG stream, capture facility 302 may capture (e.g., record, copy, etc.) data representative of the media content instance and store the captured data as a captured media content instance within storage facility 308. Capture facility 302 may be configured to capture a media content instance in any other way as may serve a particular implementation.

As mentioned, a captured media content instance may include data representative of a media content program (e.g., a television program). In some instances, the media content program may include a broadcast of a live event (e.g., a talent competition, a sporting event, etc.).

A captured media content instance may further include data representative of one or more advertisements to be presented during one or more advertisement breaks that are interspersed temporally throughout the captured media content instance. The one or more advertisements may include one or more non-targeted advertisements (e.g., national advertisements) intended for all viewers of the media content program. Additionally or alternatively, the one or more advertisements may include targeted or local advertisements intended for one or more particular viewers of the media content program. To illustrate, one or more advertisement breaks interspersed throughout the captured media content instance may be reserved for a service provider to present one or more targeted advertisements intended for users located within a certain geographic region and/or having a certain user profile.

Capture facility 302 may be further configured to receive a request provided by a user of access subsystem 104 to access, by way of access subsystem 104, a captured media content instance maintained by delivery subsystem 102. For example, capture facility 302 may receive a request provided by a user of a set-top box device to view a television program captured by delivery subsystem 102.

In response to the request to access the captured media content instance, capture facility 302 may provide the captured media content instance for presentation to the user by way of access subsystem 104. For example, capture facility 302 may direct communication facility 304 to stream the captured media content instance to access subsystem 104 for presentation to the user by way of access subsystem 104.

Communication facility 304 may be configured to facilitate communication between delivery subsystem 102 and access subsystem 104. In particular, communication facility 304 may be configured to transmit and/or receive communication signals, media content instances, metadata and/or any other data to/from access subsystem 104. For example, communication facility 304 may transmit data representative of one or more media content instances and/or advertisements to access subsystem 104. Communication facility 304 may additionally or alternatively be configured to transmit data representative of a captured media content instance to a particular media content access subsystem 104 associated with a particular user in response to a request provided by the user to access the captured media content instance.

Data representative of media content instances and captured media content instances may be transmitted in one or more media content streams, as one or more data files, or in any other suitable manner as may serve a particular implementation. Communication facility 304 may be configured to interface with any suitable communication media, protocols, and formats, including any of those mentioned above.

Advertisement management facility 306 may be configured to manage (e.g., maintain, generate, provide, and/or select) advertisements that may be presented to one or more users of access subsystem 104 during one or more advertisement breaks included in a captured media content instance. To this end, advertisement management facility 306 may detect, during a capturing of a media content instance, a trigger included in the transmission of the media content instance. The trigger may include, but is not limited to, data indicative of a start time and an end time of an advertisement break included in the media content instance. As mentioned, the trigger may precede the advertisement break in order to alert delivery subsystem 102 of an upcoming advertisement break during which one or more advertisements (e.g., one or more targeted and/or local advertisements) may be presented to one or more users.

In response to detecting the trigger, advertisement management facility 306 may dynamically update an index file associated with the captured media content instance with data representative of the start time and the end time of the advertisement break. The index file may include, but is not limited to, timestamp data representative of a temporal position (e.g., start and end times) of one or more advertisement breaks included in the captured media content instance.

Advertisement management facility 306 may be configured to use the index file to insert one or more advertisements into a presentation of the captured media content instance. Various manners in which the index file may be used to insert one or more advertisements into a presentation of a captured media content instance will be described in detail below.

Storage facility 308 may be configured to maintain captured media content instance data 310 representative of one or more captured media content instances, index data 312 representative of one or more index files corresponding to one or more captured media content instances, and advertisement data 314 representative of one or more advertisements. It will be recognized that storage facility 308 may maintain additional or alternative data as may serve a particular implementation.

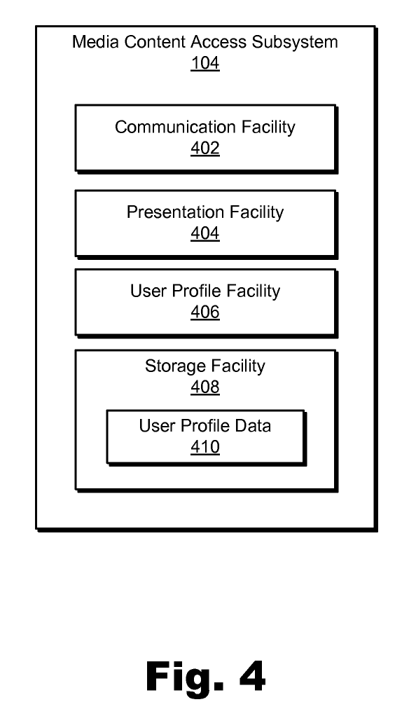

FIG. 4 illustrates exemplary components of access subsystem 104. Access subsystem 104 may be implemented as may suit a particular implementation. For example, access subsystem 104 may be implemented by a media content access device, which may include, but is not limited to, a set-top box device, a DVR device, a media content processing device, a communications device, a mobile access device (e.g., a mobile phone device, a handheld device, a laptop computer, a tablet computer, a personal-digital assistant device, etc.), a personal computer, a gaming device, a television device, and/or any other device configured to perform one or more of the processes and/or operations described herein.

As shown in FIG. 4, access subsystem 104 may include a communication facility 402, a presentation facility 404, a user profile facility 406, and a storage facility 408, which may be in communication with one another using any suitable communication technologies. It will be recognized that although facilities 402-408 are shown to be separate facilities in FIG. 4, any of those facilities may be combined into a single facility as may serve a particular implementation.

Communication facility 402 may be configured to facilitate communication between access subsystem 104 and delivery subsystem 102. In particular, communication facility 402 may be configured to transmit and/or receive communication signals, media content instances, metadata and/or any other data to/from delivery subsystem 102. Communication facility 402 may be configured to interface with any suitable communication media, protocols, and formats, including any of those mentioned above.

For example, communication facility 402 may transmit to delivery subsystem 102 a request provided by a user of access subsystem 104 to access a captured media content instance by way of access subsystem 104. In response to the request, communication facility 402 may receive from delivery subsystem 102 the captured media content instance for presentation to the user by way of access subsystem 104.

Presentation facility 404 may be configured to present one or more media content instances to a user of access subsystem 104. For example, presentation facility 404 may present a captured media content instance received from delivery subsystem 102 to a user. In some examples, the presentation of a captured media content instance may be performed linearly (e.g., normal playback) and/or non-linearly (e.g., in accordance with one or more trick play modes).

User profile facility 406 may be configured to maintain one or more user profiles associated with one or more users of access subsystem 104. Each user profile may represent how a particular user interacts with access subsystem 104, one or more personal traits and/or preferences associated with the user, and/or any other information associated with the user as may serve a particular implementation. In some examples, a user profile corresponding to a user may be dynamically updated as various interaction events performed by the user are detected by user profile facility 406.

In some examples, a user profile associated with a user may be used to present one or more targeted advertisements to the user. For example, user profile facility 406 may provide data representative of the user profile to delivery subsystem 102, which may use the data to select an advertisement for presentation to the user that targets the user.

Storage facility 408 may be configured to maintain user profile data 410 representative of one or more user profiles. It will be recognized that storage facility 312 may maintain additional or alternative data as may serve a particular implementation.

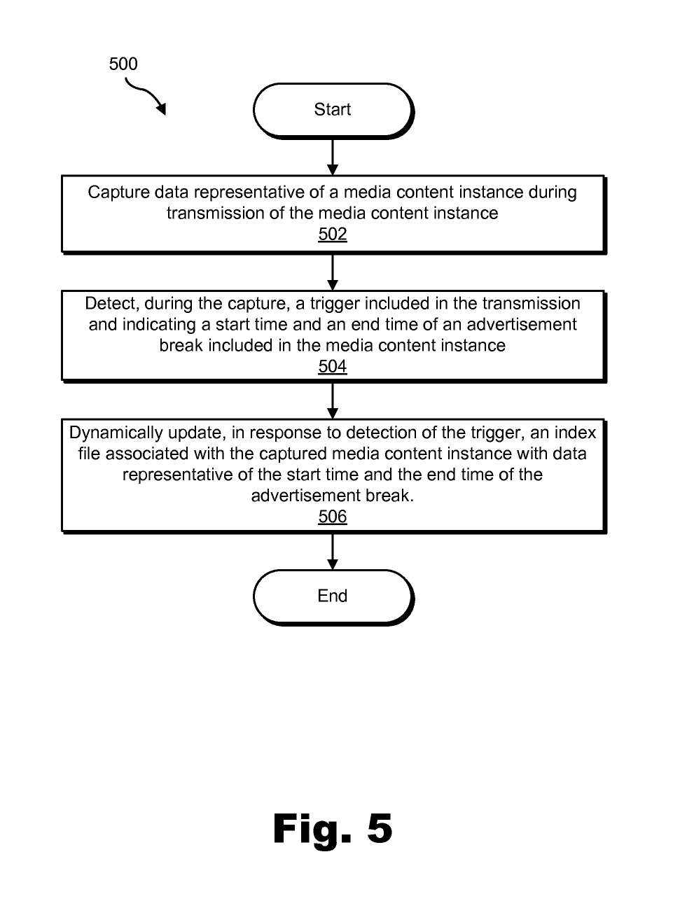

FIG. 5 illustrates an exemplary method 500 of trigger-based updating of an index file associated with a captured media content instance. While FIG. 5 illustrates exemplary steps according to one embodiment, other embodiments may omit, add to, reorder, and/or modify any of the steps shown in FIG. 5. The steps shown in FIG. 5 may be performed by any component or combination of components of delivery subsystem 102.

In step 502, data representative of a media content instance is captured during transmission of the media content instance. The resulting captured media content instance may include a media content program and one or more advertisements included in one or more advertisement breaks that are interspersed temporally throughout the captured media content instance.

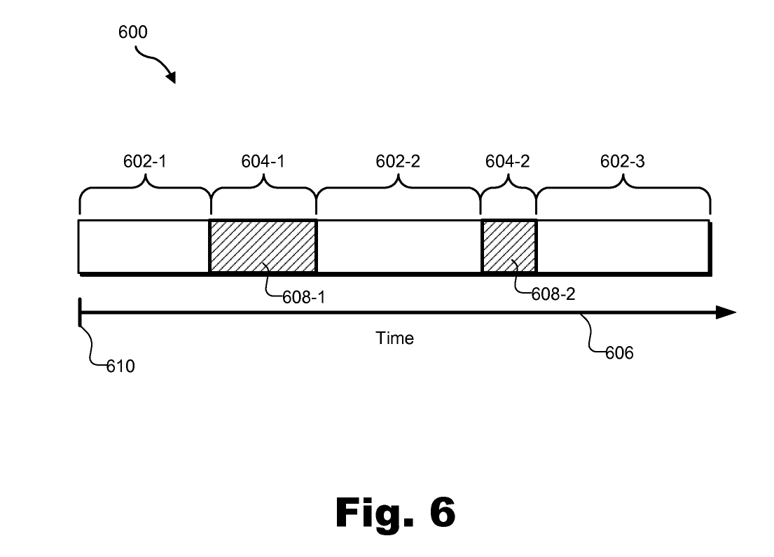

To illustrate, FIG. 6 shows a graphical representation of an exemplary captured media content instance 600. As shown in FIG. 6, captured media content instance 600 may include a media content program represented by a plurality of program segments 602 (e.g., program segments 602-1 through 602-3) and a plurality of advertisement breaks 604 (e.g., advertisement breaks 604-1 and 604-2) temporally interspersed throughout captured media content instance 600 along a time axis 606 and within which one or more advertisements 608 (e.g., advertisements 608-1 and 608-2) are included for presentation.

As illustrated in FIG. 6, captured media content instance 600 includes a beginning time 610 to which all other temporal positions along time axis 606 may be referenced. In one exemplary implementation, beginning time 610 may be represented by time “00:00” within the media content instance. Thus, a particular temporal position within captured media content instance 600 may be represented by an amount of time between beginning time 610 and the particular temporal position. For example, a temporal position within captured media content instance 600 that occurs one minute after beginning time 610 may be represented by a time 01:00. In this manner, exact temporal positions within captured media content instance 600 may be identified.

Returning to FIG. 5, in step 504, a trigger included in the transmission and indicating a start time and an end time of an advertisement break included in the media content instance is detected during the capture of the media content instance. For example, each trigger may precede a corresponding advertisement break 604 by a predefined amount of time (e.g., a few seconds) and may indicate one or more attributes of the advertisement break 604. In particular, the trigger may indicate the start time and the end time of the advertisement break 604.

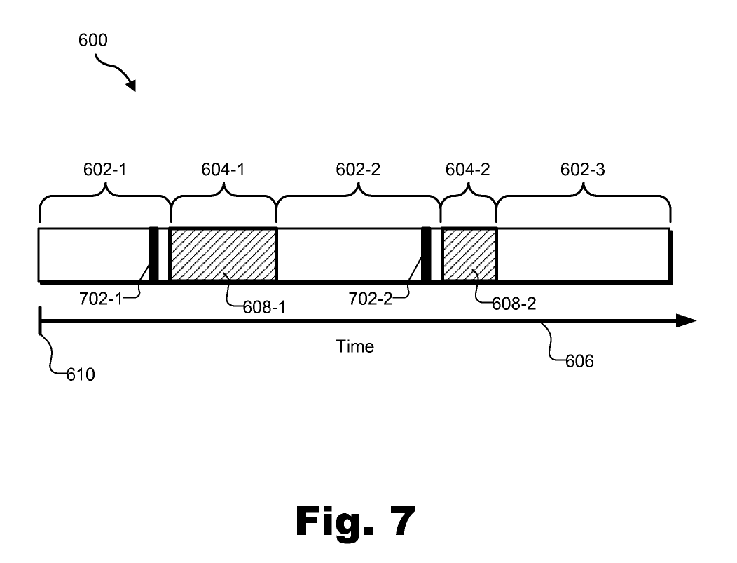

To illustrate, FIG. 7 shows triggers 702 (e.g., triggers 702-1 and 702-2) embedded in captured media content instance 600. Trigger 702-1 precedes and corresponds to advertisement break 604-1, and trigger 702-2 precedes and corresponds to advertisement break 604-2. It will be recognized that in some alternative examples, triggers 702 are not included in captured media content instance 600. Instead, triggers 702 may be transmitted separately or in a manner in which they do not appear in captured media content instance 600.

As discussed, each trigger 702 may include data representative of one or more attributes of its corresponding advertisement break 604. For example, trigger 702-1 may include data that indicates the start time and the end time of advertisement break 604-1 (e.g., with respect to the beginning time 610). Likewise, trigger 702-2 may indicate the start time and the end time of advertisement break 604-2.

Returning to FIG. 5, in step 506, an index file associated with the captured media content instance is dynamically updated, in response to the detection of the trigger, with data representative of the start time and the end time of the advertisement break. The index file may be dynamically updated in any suitable manner as may serve a particular implementation.

For example, delivery subsystem 102 may create an index file associated with the captured media content instance if one does not already exist. To illustrate, upon detecting the first occurrence of a trigger (e.g., trigger 702-1) in a media content instance being captured, delivery subsystem 102 may create an index file and include data representative of the start and end times of an advertisement break (e.g., advertisement break 604-1) associated with the trigger and consecutively update the index file with data representative of the start time and the end of the advertisement break. Delivery subsystem 102 may then dynamically update the index file in response to detecting subsequent triggers (e.g., trigger 702-2).

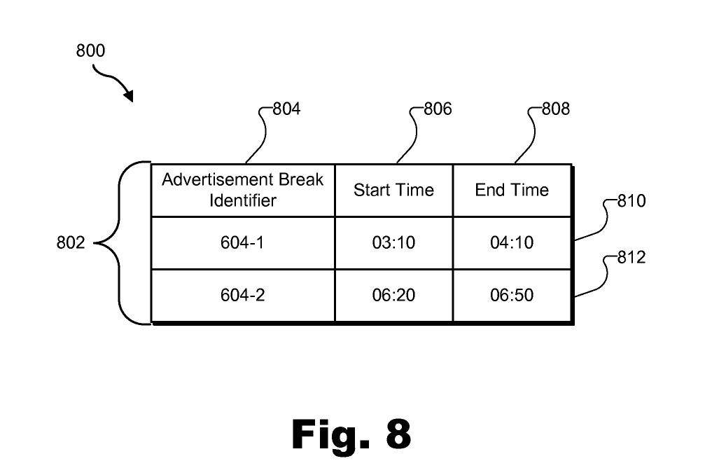

FIG. 8 shows a graphical representation of an exemplary index file 800 that may be associated with captured media content instance 600. Index file 800 may be a text file, an extensible markup language (“XML”) file, or any other type of file in any suitable format as may serve a particular implementation.

As shown in FIG. 8, data included in index file 800 may be arranged in the form of a table 802. However, it will be recognized that the data may be arranged within index file 800 in any other suitable manner as may serve a particular implementation.

As illustrated in FIG. 8, table 802 may include an “advertisement break identifier” column 804 that includes identification data representative of each advertisement break within captured media content instance 600. For example, column 804 identifies advertisement breaks 604-1 and 604-2 as being included within captured media content instance 600. The identification data may include any suitable identifier for each advertisement break as specified by the detected triggers as may serve a particular implementation. In some alternative examples, index file 800 does not include the data shown in column 804. Rather, index file 800 may only include data representative of the start and end times of each advertisement break.

As shown in FIG. 8, table 802 may also include a “start time” column 806 that includes data representative of a start time of each advertisement break included in captured media content instance 600. For example, column 806 illustrates that advertisement break 604-1 has a start time of 03:10, or three minutes and ten seconds after the beginning time 610 of captured media content instance 600. Likewise, FIG. 8 illustrates that advertisement break 604-2 has a start time of 06:20, or six minutes and twenty seconds after the beginning time 610.

Table 802 may also include an “end time” column 808 that includes data representative of an end time of each advertisement break included in captured media content instance 600. For example, column 808 illustrates that advertisement break 604-1 has an end time of 04:10, or four minutes and ten seconds from the beginning time 610 of the media content instance 600. Likewise, FIG. 8 illustrates that advertisement break 604-2 has an end time of 06:50, or six minutes and fifty seconds after the beginning time 610.

As mentioned, a captured media content instance and its associated index file may be maintained (e.g., stored in storage facility 308) by delivery subsystem 102 and selectively provided to access subsystem 104. For example, delivery subsystem 102 may receive a request provided by a user of access subsystem 104 to access the captured media content instance by way of access subsystem 104. In response to the request, delivery subsystem 102 may provide the captured media content instance for presentation to the user by way of the media content access subsystem 104. For example, delivery subsystem 102 may stream data representative of the captured media content instance to access subsystem 104 in the form of a video-on-demand asset or in any other suitable form as may serve a particular implementation.

In some examples, delivery subsystem 102 may use the index file associated with the captured media content instance to insert one or more advertisements not originally included in the captured media content instance into a presentation of the captured media content instance. Various manners in which delivery subsystem 102 may use the index file to insert one or more advertisements into a presentation of the captured media content instance will now be described. It will be recognized that the examples provided herein are merely illustrative of the many different ways in which an index file may be utilized to insert one or more advertisements into a captured media content instance.

In some examples, delivery subsystem 102 may use the index file to identify the start time of an advertisement break included in the captured media content instance and provide a new advertisement for presentation to the user by way of access subsystem 104 in place of the captured media content instance during a time period that begins at the identified start time of the advertisement break. Delivery subsystem 102 may further use the index file to identify the end time of the advertisement break and direct access subsystem 104 to resume, upon completion of the presentation of the advertisement, presentation of the captured media content instance at a temporal position that corresponds to the identified end time of the advertisement break.

For example, delivery subsystem 102 may use index file 800 to identify the start and end times of advertisement breaks 604-1 and 604-2 in captured media content instance 600. Based on the identified start and end times, delivery subsystem 102 may select and provide one or more advertisements for presentation in place of advertisements 608-1 and 608-2 originally included in advertisement breaks 604-1 and 604-2.

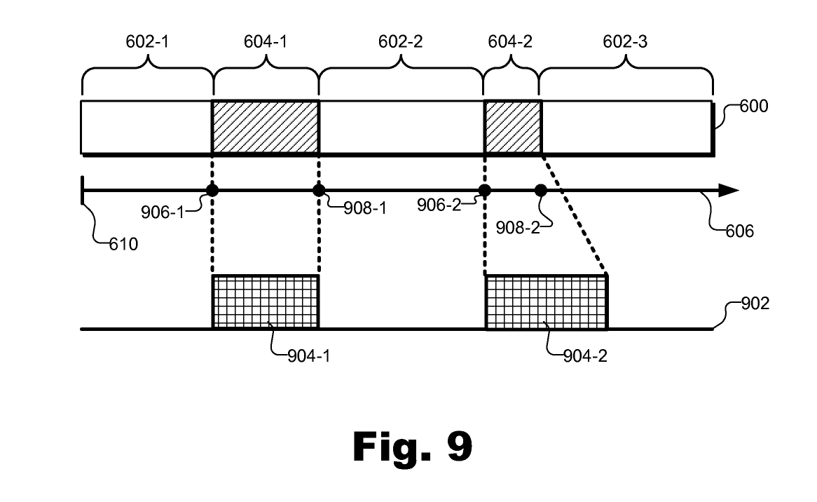

To illustrate, FIG. 9 shows captured media content instance 600 along with a graphical representation of an advertisement stream 902 that includes advertisements 904-1 and 904-2 (collectively “advertisements 904”) that may be presented in place of captured media content instance 600 during time periods associated with advertisement breaks 604. As shown in FIG. 9, advertisement stream 902 may otherwise include blank content (i.e., lack advertising content).

In some examples, a user may direct access subsystem 104 to begin presenting captured media content instance 600 at a temporal position corresponding to beginning time 610. When the presentation reaches a temporal position corresponding to a start time 906-1 of advertisement break 604-1, delivery subsystem 102 may provide advertisement 904-1 for presentation by way of access subsystem 104 in place of captured media content instance 600. For example, delivery subsystem 102 may direct access subsystem 104 to switch (e.g., tune) to a channel carrying advertisement stream 902 when the presentation reaches the start time 906-1 of advertisement break 604-1. In this manner, advertisement 904-1 may be presented in place of advertisement 608-1 during a time period associated with advertisement break 604-1. Delivery subsystem 102 may provide advertisement 904-1 for presentation beginning at the start time 906-1 of advertisement break 604-1 in any other manner as may serve a particular implementation.

Upon completion of the presentation of advertisement 904-1, delivery subsystem 102 may direct access subsystem 104 to resume presentation of captured media content instance 600 at a temporal position within captured media content instance 600 that corresponds to an identified end time 908-1 of advertisement break 604-1. For example, delivery subsystem 102 may direct access subsystem 104 to switch (e.g., tune) back to the channel carrying captured media content instance 600 at a temporal position within captured media content instance 600 that corresponds to end time 908-1 of advertisement break 604-1.

Continuing with the example of FIG. 9, delivery subsystem 102 may provide another advertisement 904-2 for presentation beginning at a temporal position within captured media content instance 600 that corresponds to a start time 906-2 of advertisement break 604-2. For example, delivery subsystem 102 may direct access subsystem 104 to switch (e.g., tune) to the channel carrying advertisement stream 902 when the presentation reaches the start time 906-2 of advertisement break 604-2. In this manner, advertisement 904-2 may be presented in place of advertisement 608-2 during a time period associated with advertisement break 604-2.

Upon completion of the presentation of advertisement 904-2, delivery subsystem 102 may direct access subsystem 104 to resume presentation of captured media content instance 600 (e.g., by directing access subsystem 104 to switch back to the channel carrying captured media content instance 600) at a temporal position within captured media content instance 600 that corresponds to an identified end time 908-2 of advertisement break 604-2.

As illustrated in FIG. 9, by resuming presentation of captured media content instance 600 at a temporal position that corresponds to an identified end time of an advertisement break, one or more advertisements of any duration may be presented during a time period associated with the advertisement break. The time period associated with the advertisement break may dynamically vary depending on the duration of the one or more advertisements.

To illustrate, an advertisement originally included in a captured media content instance (e.g., advertisement 608-1) may be dynamically replaced by an advertisement (e.g., advertisement 904-1) that has a substantially equivalent duration as the originally included advertisement. In other words, the time period during which the new advertisement is presented is substantially equal to a difference in time between the start time and the end time of the advertisement break.

Alternatively, an advertisement originally included in a captured media content instance (e.g., advertisement 608-2) may be dynamically replaced by an advertisement (e.g., advertisement 904-2) that has relatively longer duration than the originally included advertisement. In other words, the time period during which the new advertisement is presented is longer than a difference in time between the start time and the end time of the advertisement break.

In yet another alternative embodiment, an advertisement originally included in a captured media content instance may be dynamically replaced by an advertisement that has relatively shorter duration than the originally included advertisement. In other words, the time period during which the new advertisement is presented is shorter than a difference in time between the start time and the end time of the advertisement break.

An index file associated with a captured media content instance may further facilitate dynamic insertion of one or more advertisements into a presentation of the captured media content instance even when the captured media content instance is being accessed in accordance with one or more trick play modes. For example, a user may fast forward captured media content instance 600 and begin presenting captured media content instance 600 during the middle of advertisement break 604-1. Delivery subsystem 102 may detect a temporal position within captured media content instance 600 at which the presentation begins, determine based on index file 800 that the temporal position is included in a range of temporal positions associated with advertisement break 604-1, and provide an advertisement for presentation during a remaining time period associated with advertisement break 604-1.

In some examples, the same dynamically inserted advertisement (e.g., advertisement 904-1) may be presented each time the user accesses a captured media content instance (e.g., captured media content instance 600). Alternatively, delivery subsystem 102 may be configured to present a new advertisement during a time period associated with an advertisement break (e.g., advertisement break 604-1) each time (or after a predetermined number of times) the captured media content instance is accessed by the user. To this end, delivery subsystem 102 (e.g., advertisement management facility 306) may be configured to track a number of times that each advertisement is presented to a user. The tracking information may be used by delivery subsystem 102 to generate and/or select new advertisements for presentation to the user.

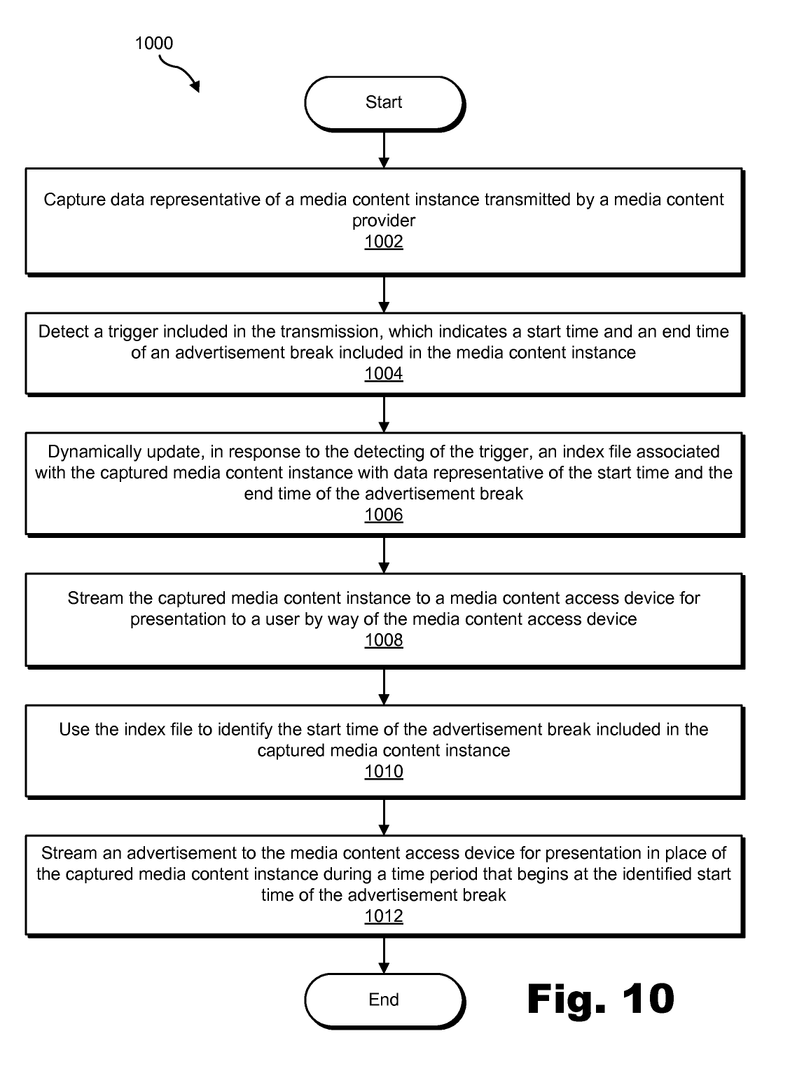

FIG. 10 illustrates an exemplary method 1000 of dynamically inserting an advertisement into a presentation of a captured media content instance. While FIG. 10 illustrates exemplary steps according to one embodiment, other embodiments may omit, add to, reorder, and/or modify any of the steps shown in FIG. 10. The steps shown in FIG. 10 may be performed by any component or combination of components of delivery subsystem 102.

In step 1002, a service provider subsystem captures data representative of a media content instance transmitted by a media content provider. The media content instance may be captured in any of the ways described herein and may result in a captured media content instance.

In step 1004, the service provider subsystem detects a trigger included in the transmission and indicating a start time and an end time of an advertisement break included in the media content instance. The trigger may be detected in any of the ways described herein.

In step 1006, the service provider subsystem dynamically updates, in response to the detecting of the trigger, an index file associated with the captured media content instance with data representative of the start time and the end time of the advertisement break. The index file may be updated in any of the ways as described herein.

In step 1008, the service provider subsystem streams the captured media content instance to a media content access device for presentation to a user by way of the media content access device. The service provider subsystem may stream the captured media content to the media content device in any of the ways as described herein.

In step 1010, the service provider subsystem uses the index file to identify the start time of the advertisement break included in the captured media content instance. The index file may be used to identify the start time of the advertisement break in any of the ways described herein.

In step 1012, the service provider subsystem streams an advertisement to the media content access device for presentation in place of the captured media content instance during a time period that begins at the identified start time of the advertisement break. The service provider subsystem may stream the advertisement in any of the ways described herein.

In certain embodiments, one or more of the components and/or processes described herein may be implemented and/or performed by one or more appropriately configured computing devices. To this end, one or more of the systems and/or components described above may include or be implemented by any computer hardware and/or computer-implemented instructions (e.g., software), or combinations of computer-implemented instructions and hardware, configured to perform one or more of the processes described herein. In particular, system components may be implemented on one physical computing device or may be implemented on more than one physical computing device. Accordingly, system components may include any number of computing devices, and may employ any of a number of computer operating systems.

In certain embodiments, one or more of the processes described herein may be implemented at least in part as instructions embodied in a non-transitory computer-readable medium and executable by one or more computing devices. In general, a processor (e.g., a microprocessor) receives instructions, from a non-transitory computer-readable medium, (e.g., a memory, etc.), and executes those instructions, thereby performing one or more processes, including one or more of the processes described herein. Such instructions may be stored and/or transmitted using any of a variety of known computer-readable media.

A computer-readable medium (also referred to as a processor-readable medium) includes any non-transitory medium that participates in providing data (e.g., instructions) that may be read by a computer (e.g., by a processor of a computer). Such a medium may take many forms, including, but not limited to, non-volatile media, and/or volatile media. Non-volatile media may include, for example, optical or magnetic disks and other persistent memory. Volatile media may include, for example, dynamic random access memory (“DRAM”), which typically constitutes a main memory. Common forms of computer-readable media include, for example, a floppy disk, flexible disk, hard disk, magnetic tape, any other magnetic medium, a CD-ROM, DVD, any other optical medium, a RAM, a PROM, an EPROM, a FLASH-EEPROM, any other memory chip or cartridge, or any other tangible medium from which a computer can read.

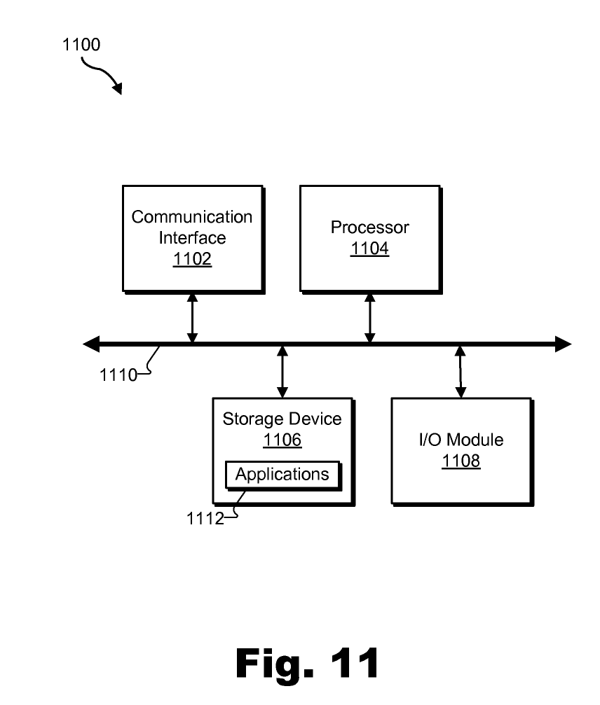

FIG. 11 illustrates an exemplary computing device 1100 that may be configured to perform one or more of the processes described herein. As shown in FIG. 11, computing device 1100 may include a communication interface 1102, a processor 1104, a storage device 1106, and an input/output (“I/O”) module 1108 communicatively connected via a communication infrastructure 1110. While an exemplary computing device 1100 is shown in FIG. 11, the components illustrated in FIG. 11 are not intended to be limiting. Additional or alternative components may be used in other embodiments. Components of computing device 1100 shown in FIG. 11 will now be described in additional detail.

Communication interface 1102 may be configured to communicate with one or more computing devices. Examples of communication interface 1102 include, without limitation, a wired network interface (such as a network interface card), a wireless network interface (such as a wireless network interface card), a modem, and any other suitable interface. In at least one embodiment, communication interface 1102 may provide a direct connection between system 100 and one or more of provisioning systems via a direct link to a network, such as the Internet. Communication interface 1102 may additionally or alternatively provide such a connection through, for example, a local area network (such as an Ethernet network), a personal area network, a telephone or cable network, a satellite data connection, a dedicated URL, or any other suitable connection. Communication interface 1102 may be configured to interface with any suitable communication media, protocols, and formats, including any of those mentioned above.

Processor 1104 generally represents any type or form of processing unit capable of processing data or interpreting, executing, and/or directing execution of one or more of the instructions, processes, and/or operations described herein. Processor 1104 may direct execution of operations in accordance with one or more applications 1112 or other computer-executable instructions such as may be stored in storage device 1106 or another computer-readable medium.

Storage device 1106 may include one or more data storage media, devices, or configurations and may employ any type, form, and combination of data storage media and/or device. For example, storage device 1106 may include, but is not limited to, a hard drive, network drive, flash drive, magnetic disc, optical disc, random access memory (“RAM”), dynamic RAM (“DRAM”), other non-volatile and/or volatile data storage units, or a combination or sub-combination thereof. Electronic data, including data described herein, may be temporarily and/or permanently stored in storage device 1106. For example, data representative of one or more executable applications 1112 (which may include, but are not limited to, one or more of the software applications described herein) configured to direct processor 1104 to perform any of the operations described herein may be stored within storage device 1106. In some examples, data may be arranged in one or more databases residing within storage device 1106.

I/O module 1108 may be configured to receive user input and provide user output and may include any hardware, firmware, software, or combination thereof supportive of input and output capabilities. For example, I/O module 1108 may include hardware and/or software for capturing user input, including, but not limited to, a keyboard or keypad, a touch screen component (e.g., touch screen display), a receiver (e.g., an RF or infrared receiver), and/or one or more input buttons.

I/O module 1108 may include one or more devices for presenting output to a user, including, but not limited to, a graphics engine, a display (e.g., a display screen, one or more output drivers (e.g., display drivers), one or more audio speakers, and one or more audio drivers. In certain embodiments, I/O module 1108 is configured to provide graphical data to a display for presentation to a user. The graphical data may be representative of one or more graphical user interfaces and/or any other graphical content as may serve a particular implementation.

In some examples, any of the facilities described herein may be implemented by or within one or more components of computing device 1100. For example, one or more applications 1112 residing within storage device 1106 may be configured to direct processor 1104 to perform one or more processes or functions associated with capture facility 302, communication facility 304, advertisement management facility 306, communication facility 402, presentation facility 404, and/or user profile facility 406. Likewise, storage facility 308 and/or storage facility 408 may be implemented by or within storage device 1106.

It will be recognized that any other technique for inserting an advertisement into a presentation of a captured media content instance may be used in accordance with the methods and systems herein. For example, the advertisement may be selected and actually inserted into the captured media content instance as the captured media content instance is streamed to access subsystem 104. Alternatively, delivery subsystem 102 may modify the captured media content instance with data representative of the advertisement before the captured media content instance is provided to access subsystem 104.

In the preceding description, various exemplary embodiments have been described with reference to the accompanying drawings. It will, however, be evident that various modifications and changes may be made thereto, and additional embodiments may be implemented, without departing from the scope of the invention as set forth in the claims that follow. For example, certain features of one embodiment described herein may be combined with or substituted for features of another embodiment described herein. The description and drawings are accordingly to be regarded in an illustrative rather than a restrictive sense.

What is claimed is:

1. A method comprising:
capturing, by a media content delivery subsystem, data representative of a media content instance during a transmission of the media content instance, the capturing resulting in a captured media content instance;
detecting, by the media content delivery subsystem during the capturing, a trigger included in the transmission and indicating a start time and an end time of an advertisement break included in the media content instance; and
dynamically updating, by the media content delivery subsystem in response to the detecting of the trigger, an index file associated with the captured media content instance with data representative of the start time and the end time of the advertisement break.

2. The method of claim 1, wherein the trigger comprises an SCTE-35 cue tone.

3. The method of claim 1, further comprising providing, by the media content delivery subsystem, the captured media content instance for presentation by way of a media content access device as a video-on-demand asset.

4. The method of claim 1, wherein the start time and the end time of the advertisement break are relative to a beginning time of the captured media content instance.

5. The method of claim 1, further comprising maintaining, by the media content delivery subsystem, the index file in a storage device included within the media content delivery subsystem.

6. The method of claim 1, further comprising:
receiving, by the media content delivery subsystem, a request provided by a user of a media content access subsystem to access the captured media content instance by way of the media content access subsystem; and
providing, by the media content delivery subsystem in response to the request, the captured media content instance for presentation to the user by way of the media content access subsystem.

7. The method of claim 6, further comprising:
using, by the media content delivery subsystem, the index file to identify the start time of the advertisement break included in the captured media content instance; and
providing, by the media content delivery subsystem, an advertisement for presentation to the user by way of the media content access subsystem in place of the captured media content instance during a time period that begins at the identified start time of the advertisement break.

8. The method of claim 7, further comprising:
using, by the media content delivery subsystem, the index file to identify the end time of the advertisement break included in the captured media content instance; and
directing, by the media content delivery subsystem, the media content access subsystem to resume presentation of the captured media content instance at a temporal position within the captured media content instance that corresponds to the identified end time of the advertisement break upon completion of the presentation of the advertisement.

9. The method of claim 7, further comprising selecting, by the media content delivery subsystem, the advertisement to target the user in accordance with a user profile associated with the user.

10. The method of claim 7, wherein the time period is substantially equal to a difference in time between the start time and the end time of the advertisement break.

11. The method of claim 7, wherein the time period is shorter than a difference in time between the start time and the end time of the advertisement break.

12. The method of claim 7, wherein the time period is longer than a difference in time between the start time and the end time of the advertisement break.

13. The method of claim 1, wherein the transmission of the media content instance comprises a broadcast of a live event.

14. The method of claim 1, embodied as computer-executable instructions on at least one non-transitory computer-readable medium.

15. A method comprising:
capturing, by the service provider subsystem, data representative of a media content instance transmitted by a media content provider subsystem, the capturing resulting in a captured media content instance;
detecting, by the service provider subsystem during the capturing, a trigger included in the transmission and indicating a start time and an end time of an advertisement break included in the media content instance;
dynamically updating, by the service provider subsystem in response to the detecting of the trigger, an index file associated with the captured media content instance with data representative of the start time and the end time of the advertisement break;
streaming, by the service provider subsystem, the captured media content instance to a media content access device for presentation to a user by way of the media content access device;
using, by the service provider subsystem, the index file to identify the start time of the advertisement break included in the captured media content instance; and
streaming, by the service provider subsystem, an advertisement to the media content access device for presentation in place of the captured media content instance during a time period that begins at the identified start time of the advertisement break.

16. The method of claim 15, further comprising:
using, by the service provider subsystem, the index file to identify the end time of the advertisement break included in the captured media content instance; and
directing, by the service provider subsystem, the media content access subsystem to resume presentation of the captured media content instance at a temporal position within the captured media content instance that corresponds to the identified end time of the advertisement break upon completion of the presentation of the advertisement.

17. The method of claim 15, embodied as computer-executable instructions on at least one non-transitory computer-readable medium.

18. A system comprising:
a media content capture facility configured to capture data representative of a media content instance during a transmission of the media content instance, the capturing resulting in a captured media content instance; and
an advertisement management facility communicatively coupled to the media content capture facility and configured to
detect a trigger included in the transmission and indicating a start time and an end time of an advertisement break included in the media content instance, and
update an index file associated with the captured media content instance with data representative of the start time and the end time of the advertisement break.

19. The system of claim 18, further comprising a communication facility communicatively coupled to the media content capture facility and configured to provide the captured media content instance to a media content access subsystem for presentation to a user by way of the media content access subsystem.

20. The system of claim 19, wherein the advertisement management facility is further configured to:
use the index file to identify the start time of the advertisement break included in the captured media content instance; and
provide an advertisement to the media content access subsystem for presentation to the user by way of the media content access subsystem in place of the captured media content instance during a time period that begins at the identified start time of the advertisement break.

21. The system of claim 20, wherein the advertisement management facility is further configured to:
use the index file to identify the end time of the advertisement break included in the captured media content instance; and
direct the media content access subsystem to resume the presentation of the captured media content instance at a temporal position within the captured media content instance that corresponds to the identified end time of the advertisement break upon completion of the presentation of the advertisement.

22. The system of claim 21, wherein the advertisement management facility is further configured to select the advertisement to target the user in accordance with a user profile associated with the user.
